(19) United States
(12) Patent Application Publication
(10) Pub. No.: US 2008/0127560 A1
(43) Pub. Date: Jun. 5, 2008

(54) Garage door opener

(75) Inventor: Remy Harvey, Lac Kenogami (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Remy Harvey

(21) Appl. No.: 11/527,722

(22) Filed: Sep. 27, 2006

(51) Int. Cl. E05F 15/16

(52) U.S. Cl. 49/199

(57) ABSTRACT

The present invention relates to a garage door operating system and to a kit for such a system. The system includes a two-channel cable drum where each channel is of a single-cable width. A motor is affixed to the wall of the garage either on either side of the door and is used to rotatably drive the two-channel cable drum. The two-channel cable drum has a length of cable spooled around each channel, each length of cable having one end attached to the drum and another guided through a series of pulleys and attached to the bottom of one of the sides of the door. To open or close the garage door, the motor rotates the two-channel cable drum gathering or releasing the two lengths of cable in a smooth and controlled fashion. The motor has strength sufficient to open the door without the aid of a counterbalance device.

### FIELD OF THE INVENTION

The present invention relates to garage door openers. More specifically, the invention relates to garage door operating systems for the secure motorised opening and closing of a garage door without the use of a counterbalance device.

### BACKGROUND OF THE INVENTION

Several garage door operating systems are currently commercially available. In many of these manual and motorised garage door operating systems, most of the opening and closing of the garage door is done by a counterbalance system using torsion or linear extension springs or by a system of counterweights, and not by the human operator or motor drive mechanism. Linear extension springs are mounted on either side of a door and are mainly used on single-car garage doors whereas torsional springs are mounted to the header above the top of the door and are used on heavier double-car garage doors. Such counterbalance-assisted garage door operating systems require less force to open and close the door and allow for the partial opening and closing of the door.

There are basically two-types of motorised operators: trolley and jackshaft.

A trolley operator is used for most vertically-opening sectional garage doors. In a trolley operating system, a motor drive is mounted above the door in the center of the garage ceiling and a rail guides a trolley across the ceiling to and from the top of the garage doorway. As the trolley moves along the rail, the top section of the door is pushed or pulled thereby causing the door to close or open. The motor drive used in trolley operators is one of three basic types: chain drive, belt drive and screw drive. Chain drive systems use a metal chain along with a metal trolley to lift the door up and down along its tracks. Belt drive systems are similar to chain drive systems. They use flexible steel reinforced rubber belts to move the trolley along the rail, which dampen the vibrations and eliminate the noisy metal-to-metal contact of chain drive systems. Screw drive systems lift the garage door using a threaded steel rod encased in the rail mechanism. The main body of the opener is situated in the center of the garage ceiling, the rail guides the trolley and the threaded steel rod pushes the trolley. In general, these systems open and close a garage door more slowly than a chain or belt drive system, but can apply more force and thus are more powerful.

One major disadvantage of trolley operators stems from the fact that the operator usually hangs in the center of the garage ceiling—it is often encumbered with obstacles running along the ceiling (beams, pipes, etc.) or becomes an obstacle itself to the smooth operation of the door. If the trolley knocks into an obstacle, the door may be prevented from opening and closing properly: for example, the chain of the chain drive may become entangled preventing the trolley from moving along the rail. Moreover, trolley operators are not suited for garages with high ceilings such as is often the case for industrial settings.

A jackshaft operator uses a motor drive to turn the shaft of a torsional spring counterbalance system. This type of garage door operator does not require an overhead rail; the opener is situated to the side of the door. However, the more forceful torsional springs are under tremendous tension and can be extremely dangerous if tampered with. This type of system also tends to lack the required safety features that stop the doors from crushing objects in their paths and cause the doors to reverse direction if they strike something.

Furthermore, to ensure the smooth operation of these counterbalance-assisted garage door operating systems, the costly springs must be well maintained through regular lubrication. Although these counterbalance-assisted garage door operating systems allow the use of low-cost low-power motor drives, the cost to replace tired or broken springs is significant; the stronger the spring the greater the cost. In addition, extension springs must be balanced to pull on both sides of the door with the same force and torsion spring assemblies are heavy, awkward to handle, and difficult to install safely.

Moreover, should the counterbalance device of current motorised counterbalance-assisted garage door operating systems fail, the motor in most of these systems—generally of low power and being made of low-cost, low-quality material and therefore not being robust—would not be able to support the load of the garage door or operate the door safely and efficiently on its own.

Numerous garage door systems or the like are specified and known in the art.

U.S. Pat. No. 1,047,131 discloses a grain car door made of a number of superposed panels and a system for locking the door panels in an elevated or inoperative position, and for releasing the panels to permit them to return to a lower position. The system is manually driven. Rotation of a pawl-and-ratchet wheel mechanism rotates a cable drum, which in turn winds or unwinds the cables attached to the bottom panel of the door thereby lifting or lowering the panels of the door. This system requires a complex rail system in order to be able to lift and lower only certain panels of the grain door.

U.S. Pat. No. 2,277,932 discloses a door operating mechanism adaptable to garage doors. The disclosed mechanism uses a motor connected to a cable drum and a single cable wound thereon. The motor is mounted inside the garage on a platform protruding from the garage wall above the door with the cable drum positioned midway between the vertical door guide rails. A peculiar arrangement of the cable and pulley system with respect to the door that exerts equal force on either side of the door and thrusts inwardly the upper portion of the door to relieve the motor of undue strain is needed to open the door efficiently and without jamming.

U.S. Pat. No. 2,598,709 discloses a mechanism for operating a closure for an opening which includes a ceiling-mounted motorised trolley operator connected to a cable-operated door. A main disadvantage of this door operating system lies in the required ceiling mounts.

U.S. Pat. No. 2,612,371 discloses an overhead garage door operator mounted over the top of the door that uses a motorised winch mechanism and a system of wound cables to lift and lower a garage door. This system also uses pivoted link means for controlling the inward tilting movement of the door as it is lifted. Drawbacks of this system include the need for vertical and overhead clearance and the significant risk of entanglement of the cables involved.

U.S. Pat. No. 3,756,585 discloses a spiral spring counterbalance unit for lifting an overhead door having a pair of interconnected cable drums which are actuated simultaneously by a single spiral spring element, whereby the drum cables apply equal lifting forces at each side of the door to be lifted.

As such, there is a need for a simple, secure, low-maintenance and long-term cost-efficient garage door operating system that can open and close large heavy doors as well as small light doors without the use of counterbalance systems and that is not encumbered by entangled chains and obstacles along the ceiling of a garage.

### SUMMARY OF THE INVENTION

In accordance with one aspect of the present invention, there is provided a garage door operating system for opening and closing a garage door which is located in a wall and has opposite top and bottom ends, and opposite sides. The garage door operating system includes a two-channel cable drum having two channels of a single-cable width and a rotation axis. The garage door operating system further includes a first and a second length of cable each having a first end attached to a respective one of the opposite sides of the garage door, and a second end attached to a respective one of the two channels of the two-channel cable drum, a cable-guiding assembly positioned for guiding the first and second length of cable between the two-channel cable drum and the opposite sides of the garage door, and a motor comprising a driveshaft directly rotatably connected to the rotation axis of the two-channel drum, whereupon a rotation of the driveshaft opens or closes the garage door by winding or unwinding the first and second length of cable onto or off of the two-channel cable drum, the motor having a strength sufficient to open the garage door without the aid of a counterbalance device.

Preferably, the cable drum is mounted on the wall adjacent one of the opposite sides of the garage door.

In an embodiment of the garage door operating system, the cable-guiding assembly preferably includes at least one primary pulley operatively located after the two-channel cable drum and mounted proximate the top end of the garage door adjacent to the garage door. The cable-guiding assembly may also preferably include at least one secondary pulley mounted operatively after the primary pulley at right angles to the primary pulley.

Preferably, the garage door operating system may include an attachment fixture attached to each of the opposite sides of the garage door for fixing the first end of each of the first and second length of cable to the respective one of the opposite sides of the garage door.

Also preferably, the garage door operating system may include a cable tensioner for detecting cable slack connected to the first and second length of cable. In addition, it may include a limit switch connected to the motor for stopping the motor.

In accordance with another aspect of the present invention, there is provided a garage door operating kit for use in opening and closing a garage door having opposite top and bottom ends, and opposite sides. The garage door operating kit includes a two-channel drum having two channels of a single-cable width and a rotation axis. The garage door operating kit further includes a first and second length of cable each having a first end attachable to a respective one of the opposite sides of the garage door, and a second end attachable to a respective one of the two channels of the two-channel cable drum, a cable-guiding assembly for guiding the first and second length of cable between the two-channel cable drum and the opposite sides of the garage door, and a motor comprising a driveshaft for direct rotary connection to the rotation axis of the two-channel drum, whereupon in use a rotation of the driveshaft opens or closes the garage door by winding or unwinding the first and second length of cable onto or off of the two-channel cable drum, the motor having a strength sufficient to open the garage door without the aid of a counterbalance device.

In an embodiment of the garage door operating kit, the cable-guiding assembly preferably includes at least one primary pulley. The cable-guiding assembly may also preferably include at least one secondary pulley for ensuring the non-entanglement of the first or second length of cable. Preferably, the garage door operating kit may include an attachment fixture for fixing the first end of each of the first and second length of cable to a respective one of the opposite sides of the garage door.

Also preferably, the garage door operating kit may include a cable tensioner for detecting cable slack connectable to the first and second length of cable. In addition, it may include a limit switch connectable to the motor for stopping the motor.

Advantages of the present invention include a garage door operating system that is simple, secure, easy to maintain, and does not require counterbalance devices.

The objects, advantages and other features of the present invention will become more apparent and be better understood upon reading of the following non-restrictive description of the preferred embodiments of the invention, given with reference to the accompanying drawings. The accompanying drawings are given purely for illustrative purposes and should not in any way be interpreted as limiting the scope of the invention.

### BRIEF DESCRIPTION OF THE DRAWINGS

FIG. 1 is a front view of a garage door operating system as it would appear in use (motor not shown for sake of clarity), according to a preferred embodiment of the invention. Note that the two-channel cable drum is shown in cross-section illustrating the winding of a length of cable in one of the two channels.

FIG. 2 is a cross-section view of the two-channel cable drum, illustrating the superposed winding of a length of cable in one of the two channels of single-cable width, according to a preferred embodiment of the invention.

FIG. 3 is a front view of a motor of the garage door operating system illustrating the rotary connection between the driveshaft of the motor and the two-channel cable drum, according to yet another preferred embodiment of the invention.

### DESCRIPTION OF PREFERRED EMBODIMENTS OF THE INVENTION

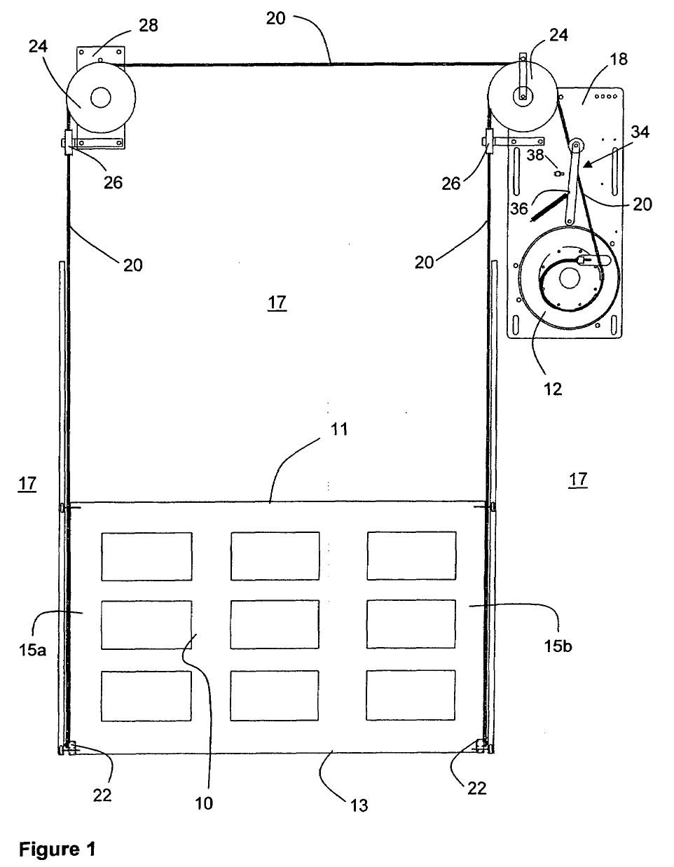

The present invention will be described more fully hereinafter with reference to the accompanying drawings, FIGS. 1, 2, and 3, in which like numerals refer to like elements throughout.

The present invention provides a garage door operating system for opening and closing a garage door (10) and a kit for installing such a system. FIG. 1 depicts most of the elements of a preferred embodiment of the system as installed for operation.

The garage door (10) is preferably of an industrial type, for example, such garage doors as found in factories and plants of different kinds, large apartment/condominium complex garages, autobody/mechanic shops and underground shopping mall parking. Of course, this does not preclude the garage door (10) from being of a residential type, for example the garage door of a single-family home. It may be of a typical single-or double-car width. It may be either a heavy or light door made of a single section or of several panel sections. The door (10) has opposite top (11) and bottom (13) ends and opposite sides, i.e. a left side (15a) and a right side (15b). It may have rollers attached along its left and right sides (15a and 15b) which engage rails fixed to the garage wall (17) on either side of the door (10)—the rollers and rail system guiding the door (10) up or down as it is opened or closed. As shown in FIG. 1, it is preferably a single-section, vertically-opening, overhead door. Nevertheless, as one versed in the domain would understand, the elements of the invention may be adaptably applied to any type of door, from a single-section or multi-section overhead door to a sectional horizontally-sliding door.

With reference to FIGS. 1, 2, and 3, the garage door operating system includes a two-channel cable drum (12), two lengths of cable (20), a cable-guiding assembly and a motor (30). It is to be noted that in FIG. 1, for sake of clarity, the motor (30) is not shown and the two-channel cable drum (12) is shown in cross section.

For ease of assembly and installation, the two-channel cable drum (12), along with some of the other elements of the garage door operating system which will be described below, is preferably mounted on a flat plate (18) and it is this flat plate (18) which is directly secured to the garage wall (17). Regardless, the two-channel cable drum (12) is preferably secured to the garage wall (17) on either side of the door (10) near the top of or above the door (10), and thus does not hinder the opening and closing of the garage door (10). Of course, it should be understood that the two-channel cable drum (12) may be mounted directly or indirectly to the garage wall (17) above the door (10) or practically anywhere along the garage wall (17), providing the system of the present invention great versatility with respect to its installation when compared to prior art designs. It has two grooves or channels (14) of a single-cable width for superposed winding of cables, and a rotation axis (16).

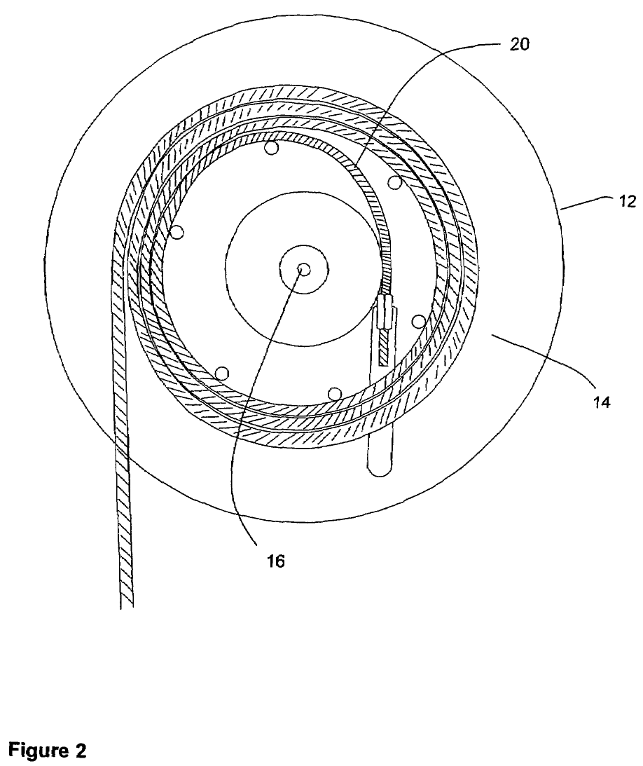

Each length of cable (20) may be made of a material of high tensile strength such as stainless steel. The two lengths of cable (20) may be two separate cables or two sections of a single cable. One end of each length of cable (20) is attached to a respective one of the two channels (14) of the two-channel cable drum (12). In this way, each length of cable (20) is wound around its respective single-width cable channel (14) in a superposed single-width coil. FIG. 2 provides a cross-section of the two-channel cable drum (12) showing the superposed winding of a length of cable (20) in a channel (14) of the cable drum (12). The other end of each length of cable (20) is attached to a respective one of the opposite sides of the garage door (10). For example, the other end of the first length of cable (20) is attached to the bottom right side (15b) of the door (10) while the other end of the second length of cable (20) is attached to the bottom left side (15a) of the door (10). This end of each length of cable (20) which is attached to the door may advantageously be provided with attachment means, such as a hook or a loop.

Preferably, a cable attachment fixture (22) adaptably attached to the door and to which the end of the length of cable (20) may be secured is also included. The attachment fixture (22) may be an appropriate corresponding cable attachment means, such as a loop or an eyelet attached directly to the door or to existing hardware of the door for engaging a hook attached to the end of the length of cable (20).

A cable-guiding assembly for guiding the first and second lengths of cable (20) between the two-channel cable drum (12) and the cable attachment fixtures (22) on the garage door (10) is provided.

The cable-guiding assembly preferably includes at least one primary pulley (24). According to the preferred embodiment of FIG. 1, the first length of cable (20) coming from the cable drum (12) is guided by a first primary pulley (24) rotatably mounted onto the flat plate (18) above the two-channel cable drum (12) down to the cable attachment fixture (22) on the right side (15b) of the door (10), and the second length of cable (20) from cable drum (12) is guided by the first primary pulley (24) to a second primary pulley (24) mounted on a flat plate (28) (for ease of assembly and installation as explained above) secured to the garage wall (17) and in turn guided by the second primary pulley (24) down to the attachment fixture (22) at the bottom of the opposite left side (15a) of the door (10). In the preferred embodiment of FIG. 1, the first primary pulley (24) is a two-channel pulley able to guide the two lengths of cable (20) separately, thereby avoiding possible entanglement of the two lengths of cable (20) and helping the smooth and efficient operation of the garage door operating system.

In addition, the cable-guiding assembly advantageously may include one or more secondary pulleys (26) mounted operatively after the primary pulley (24) for further ensuring the non-entanglement of the two lengths of cable (20) as they are guided from the cable drum (12) to the cable attachment fixtures (22). FIG. 1 shows two such secondary pulleys (26) mounted directly underneath each primary pulley (24), at right angles to their respective primary pulley (24), with their faces at right angles to both the garage wall (17) and ceiling, guiding the two lengths of cable (20) down to the attachment fixtures (22).

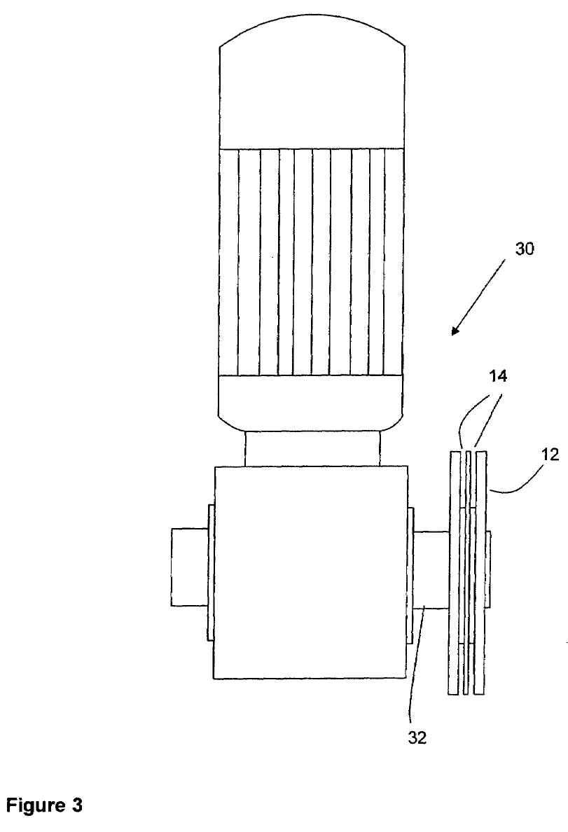

For operatively opening and closing the garage door (10), a motor (30) having a sufficient strength to operate the garage door (10) without the aid of a counterbalance device is provided. For the sake of clarity, the motor (30) itself and the connection of the motor (30) to the cable drum (12) along with any additional mounting support is not shown in FIG. 1. Nevertheless, in FIG. 3, it can be seen that the driveshaft (32) of the motor (30) is directly rotatably connected to the rotation axis of the two-channel cable drum (12). While the motor (30) is powered on, actuation of the garage door opening system causes a rotation of the driveshaft (32). Rotation of the driveshaft (32) in a given direction results in the rotation of the two-channel cable drum (12) and the winding of the first and second lengths of cable (20) onto the cable drum (12) thereby opening the garage door (10). Rotation of the driveshaft (32) in the opposite direction results in the rotation of the two-channel cable drum (12) in the opposite direction and the unwinding of the first and second lengths of cable (20) off of the cable drum (12) thereby closing the garage door (10).

Of course, although the motor (30) and two-channel cable drum (12) are preferably mounted on the garage wall (17) to the side and above the door in the embodiment of FIG. 1, one of the advantages of the operating system is that the motor (30) and cable drum (12) drive unit may be mounted at almost any position on the garage wall (17) with the use of pulleys to guide the cables as needed from the cable drum (12) to the attachment points on the door (10).

As mentioned, the motor (30) must have a sufficient strength to operate the garage door (10) without the aid of such counterbalance devices as extension or torsional springs. Motors typically used with counterbalance-assisted systems usually do not have enough strength to lift and operate the door in cases where the counterbalance system should fail. In general, a large sectional industrial garage door, 20 foot by 20 foot in area may weigh up to 1600 lbs (approximately 725 kg) whereas a small residential garage door (9 foot by 7 foot) may weigh as little as 100 lbs (approximately 45 kg). Preferably, the motor (30) is a 3 HP (3 horse power) motor capable of lifting a maximum load of approximately 725 kg (1600 lbs) through 18 feet at a speed ranging from 6 to 30 seconds. It preferably and advantageously is capable of 1000 cycles a day, that is to say, it may be used to open and close a door up to 1000 times a day. According to an embodiment of the motor (30), the motor (30) is approximately 37 cm (14.5 inches) in width and 76 cm (30 inches) in height and is encased in a housing which protects its working elements from the environment (for example from the corrosive fumes and dust found in industrial underground parking garages) and allows for little to no maintenance of the motor. The conventional motor of a counterbalance-assisted garage door operating system would not be able to sustain such rigorous use for more than a few months.

If the garage door (10) should encounter an obstacle as it is being opened or closed, the garage door operating system advantageously can provide a safety mechanism (34) connected to the first and second lengths of cable (20). The safety mechanism (34) is preferably installed at a point before the two lengths of cable (20) are split and guided to their respective cable attachment fixtures (22).

The safety mechanism (34) preferably includes a cable tensioner (36) for detecting any slack in either of the two lengths of cable (20), and a limit switch (38) connected to the motor (30) for stopping the motor. When the cable tensioner detects slack in either of the two lengths of cable (20), as would be the case if the door (10) were to encounter an obstacle mid-operation, it triggers the limit switch (38) switching off the motor (30) and preventing the obstacle from being crushed and the operating system from being damaged.

It should be noted that the scale of the objects in FIG. 1 is not accurate. Certain elements, such as the two-channel cable drum (12), and lengths have been enlarged in the drawing for the sake of clarity. A person skilled in the art will also comprehend equivalents—that minor changes in the size, form and construction of the various parts may be made and substituted for those shown herein without departing from the scope of the invention.

Because of the versatile positioning of the motor (30) and cable drum (12) along the garage wall (17), specifically their positioning to the side of the garage door (10), and the lack of ceiling mounts, this garage door operating system is appropriate for garages and garage doors lacking overhead clearance. In addition, the two-channel cable drum (12) with its single-cable width channels (14) along with the primary and secondary pulleys, ensure that the cables do not become entangled and consequently the smooth, secure and proper operation of the garage door operating system.

Another advantage of this system is its low maintenance. Other than the motor, this system relies on only a few moving parts and therefore requires minimal maintenance. There are no springs to be regularly lubricated, calibrated or replaced. Whereas the motor required for this system may cost more upfront than those used with counterbalance devices, in the long run the cost of operation is less when one factors in the cost of spring replacement and maintenance of the counterbalance-assisted systems.

Furthermore, in order to be able to lift the more heavy doors, conventional counterbalance-assisted systems require more powerful and therefore more costly springs. In the case of powerful torsional springs, with the cost of maintenance comes the added safety concern. Calibration or replacement of torsional springs must be effected carefully by skilled workers. Moreover, torsional spring systems generally cannot detect when the door is crushing an obstacle, for example a car or person. Advantageously, the garage door operating system of the present invention does not require use of costly and potentially dangerous springs, but rather provides a powerful motor, typically two to three times more powerful than conventional counterbalance-assisted motors, and a desired safety mechanism which will halt the motion of the door should the door come into contact with an obstacle.

Conventional garage door operating systems do not invest in powerful motors—they use low-cost low-power motors and consequently need a counterbalance system to be able to open and close a garage door. It is to be understood that a counterbalance-assisted garage door operating system is a system that uses a counterbalance force to balance the load of the garage door and/or reduce the work that must be done by the operator, be it a human operator or a motor operator, to open and/or close the door. For example, the counterbalance force in most counterbalance-assisted garage door operating systems is provided by springs (for example, torsion or linear expansion springs) or weights (also referred to as counterweights) and may include block and tackle pulley systems.

The present garage door system uses the brut force of a powerful motor and thereby eliminates the need for a counterbalance device to open and close a garage door, even when this door is one of the more heavy industrial garage doors. Advantageously, the number of components and the maintenance required to ensure the efficient and secure operation of the system is reduced. In addition, all of this makes the present system more versatile when it comes to mounting the system since the geometry of the layout of the elements of the system is not restricted by the use of counterbalance devices such as springs and is therefore adaptable to various types of garages, including garages with low overhead clearance and garages with extremely high ceilings, garages where the door lifts up vertically or slides across horizontally to open.

Numerous modifications could be made to any of the embodiments described above without departing from the scope of the present invention as defined in the appended claims.

1. A garage door operating system for opening and closing a garage door which is located in a wall and has opposite top and bottom ends and opposite sides, said garage door operating system comprising:
a two-channel cable drum having two channels of a single-cable width and a rotation axis;
a first and a second length of cable each having a first end attached to a respective one of the opposite sides of the garage door, and a second end attached to a respective one of said two channels of said two-channel cable drum;
a cable-guiding assembly positioned for guiding said first and second length of cable between the two-channel cable drum and the opposite sides of the garage door; and
a motor comprising a driveshaft directly rotatably connected to the rotation axis of the two-channel drum, whereupon a rotation of said driveshaft opens or closes said garage door by winding or unwinding said first and second length of cable onto or off of said two-channel cable drum, said motor having a strength sufficient to open said garage door without the aid of a counterbalance device.

2. A garage door operating system according to claim 1, wherein said cable drum is mounted on the wall adjacent one of the opposite sides of the garage door.

3. A garage door operating system according to claim 1, wherein said cable-guiding assembly comprises at least one primary pulley operatively located after the two-channel cable drum and mounted proximate the top end of the garage door adjacent to the garage door.

4. A garage door operating system according to claim 3, wherein said at least one primary pulley comprises a two-channel pulley.

5. A garage door operating system according to claim 3, wherein said at least one primary pulley comprises two such primary pulleys each mounted adjacent to a respective one of the opposite sides of the garage door.

6. A garage door operating system according to claim 3, wherein said cable-guiding assembly further comprises at least one secondary pulley mounted operatively after the at least one primary pulley, at right angles thereto.

7. A garage door operating system according to claim 1, further comprising an attachment fixture attached to each of said opposite sides of the garage door for fixing said first end of each of said first and second length of cable to said respective one of the opposite sides of the garage door.

8. A garage door operating system according to claim 1, further comprising a cable tensioner for detecting cable slack connected to said first and second length of cable.

9. A garage door operating system according to claim 1, further comprising a limit switch connected to said motor for stopping said motor.

10. A garage door operating kit for use in opening and closing a garage door having opposite top and bottom ends, and opposite sides, said garage door operating kit comprising:
a two-channel cable drum having two channels of a single-cable width and a rotation axis;
a first and a second length of cable each having a first end attachable to a respective one of the opposite sides of the garage door, and a second end attachable to a respective one of said two channels of said two-channel cable drum;
a cable-guiding assembly for guiding said first and second length of cable between said two-channel cable drum and the opposite sides of the garage door; and
a motor comprising a driveshaft for direct rotary connection to the rotation axis of the two-channel drum, whereupon in use a rotation of said driveshaft opens or closes said garage door by winding or unwinding said first and second length of cable onto or off of said two-channel cable drum, said motor having a strength sufficient to open said garage door without the aid of a counterbalance device.

11. A garage door operating kit according to claim 10, wherein said first end of each of said first and second length of cable further comprises a hook.

12. A garage door operating kit according to claim 10, wherein said cable-guiding assembly comprises at least one primary pulley.

13. A garage door operating kit according to claim 12, wherein said at least one primary pulley comprises a two-channel pulley.

14. A garage door operating kit according to claim 12, wherein said cable-guiding assembly further comprises at least one secondary pulley.

15. A garage door operating kit according to claim 10, further comprising an attachment fixture for fixing said first end of a respective one of said first and second length of cable to a respective one of the opposite sides of the garage door.

16. A garage door operating kit according to claim 10, further comprising a cable tensioner for detecting cable slack connectable to said first and second length of cable.

17. A garage door operating kit according to claim 10, further comprising a limit switch connectable to said motor for stopping said motor.
